(19) United States
(12) Patent Application Publication
(10) Pub. No.: US 2003/0086264 A1
(43) Pub. Date: May 8, 2003

(54) Shaping unit for flexible lamp pipe

(75) Inventor: Peter K. H. Huang, Taipei (TW)

Correspondence Address: DOUGHERTY & TROXELL, SUITE 1404, 5205 LEESBURG PIKE, FALLS CHURCH, VA, 22041, US

(73) Assignee: Shining Blick Enterprises Co., Ltd.

(21) Appl. No.: 09/985,210

(22) Filed: Nov. 2, 2001

(51) Int. Cl. F21S 4/00; F21V 19/02

(52) U.S. Cl. 362/250; 362/252; 362/278; 362/220; 362/225

(57) ABSTRACT

A shaping unit for a flexible lamp pipe, having a partial length of a desired pattern for the flexible lamp pipe, the shaping unit is provided with fixing means and an engaging portion for the flexible lamp pipe; the unit is fixed on a mounting surface of the desired pattern by means of the fixing means, the flexible lamp pipe is fixed on engaging portions of a plurality of such shaping units positioned in corresponding to the pattern. By connecting of the shaping units, the flexible lamp pipe can be fast, conveniently and accurately positioned neatly and orderly in the pattern.

### BACKGROUND OF THE INVENTION

1. Field of the Invention

The present invention is related to a shaping unit for a flexible lamp pipe, and especially to such a shaping unit able of positioning the flexible lamp pipe to form it into any of various patterns.

2. Description of the Prior Art

A conventional X'mas lamp string is comprised of a lot of lamp bulbs, a plurality of such lamp strings are serially connected to get a desired length, however, the electric wires thereof can only bear a predetermined load. The number of the lamp strings is limited on the one hand, and on the other hand, such conventional X′mas lamp strings are not easy to make a pattern.

The U.S. Pat. No. 4,812,956 provides a flexible lamp-string device, wherein, a groove is provided in a flexible inner pipe, the groove is placed therein a plurality of lamp strings and then is coated with a PVC pipe. Thereby, the entire lamp-string device forms a lamp pipe with a suitable size and diameter; not only the internal lamp strings thereof are variant in fashion, but also the lamp pipe can be cut or connected to form various patterns, letters or the like.

However, in such flexible lamp pipes, it always needs to use small positioning members to connect each section of the flexible lamp pipes of a predetermined length available or obtained by cutting. The small positioning members are spaced to make the flexible lamp pipes desired patterns, letters or similar decorative patterns. Such conventional pattern-forming modes by means of flexible small positioning members are undesired by virtue that, on the one hand, the amount of the flexible small positioning members required results inconvenient working; and on the other hand, the patterns completed are undesirable in accuracy. For example, if a continuously curved pattern is desired, all the sections of the curve may be uneven; or if a number or a letter is to be formed, the number or letter may be not neat or orderly.

### SUMMARY OF THE INVENTION

The object of the present invention is to provide a shaping unit for a flexible lamp pipe, wherein, a unit is provided for shaping a part of a desired pattern, the shaping unit is provided with a plurality of fixing means and engaging portions integrally formed with the fixing means. The unit is fixed on a mounting surface of a pattern for the flexible lamp pipe; the flexible lamp pipe is mounted and positioned in conformity with the shape of the unit. By connecting of a plurality of such shaping units, a desired pattern, letter or the like can be constructed fast, conveniently and precisely.

The present invention will be apparent in its novelty and features after reading the detailed description of the preferred embodiment thereof in reference to the accompanying drawings.

### BRIEF DESCRIPTION OF THE DRAWINGS

FIG. 1 is a perspective view showing a referred embodiment of the present invention;

FIG. 2 is a partially sectional front view showing positioning of the flexible lamp pipe of FIG. 1

FIG. 3 is an end sectional view of the flexible lamp pipe of FIG. 2;

FIG. 4 is a top view taken from FIG. 2;

FIG. 5 is a perspective view showing the first pattern embodiment of the present invention;

FIG. 6 is a perspective view showing the second pattern embodiment of the present invention;

FIG. 7 is a perspective view showing the third pattern embodiment of the present invention; and

FIG. 8 is a perspective view showing the fourth pattern embodiment of the present invention.

### DETAILED DESCRIPTION OF THE PREFERRED EMBODIMENT

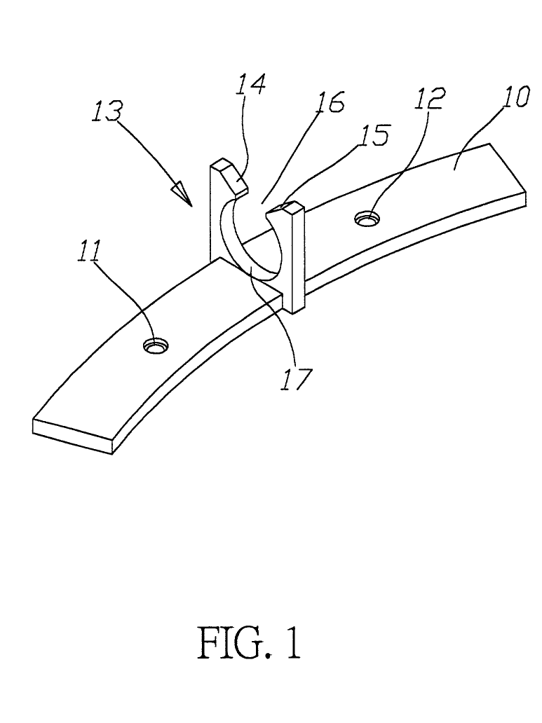

Referring to FIG. 1, the present invention is provided with a shaping unit 10 of a partial length of a desired pattern, the shaping unit 10 is provided with fixing means 11, 12, a engaging portion 13 is integrally formed on the shaping unit 10. In the embodiment shown, the shaping unit 10 is suitable for connecting mutually to form a pattern of with a continuous curve, and can be of a predetermined length in the shape of an arciform piece able to connect with other such shaping units. In an example of a wall for mounting them on, the fixing means 11, 12 thereof are two fixing holes in this embodiment. The engaging portion 13 extends upwardly to form an opening 16 with two declining leading lateral surfaces 14, 15, a notch 17 in corresponding with a flexible lamp pipe 20 is communicated with the opening 16 of a smaller width.

The above stated engaging portion 13 of the shaping unit 10 can certainly be some other fastening members or tying belts; while the fixing holes 11, 12 can be substituted by stickers or these are all adopted.

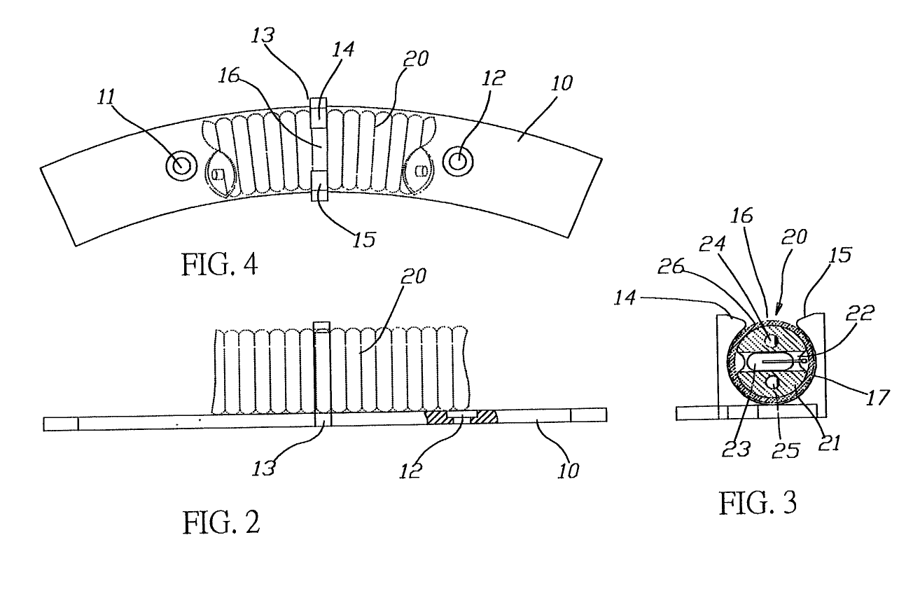

As shown in FIGS. 2-4, taking a flexible lamp pipe 20 as an example, a flexible inner pipe 21 thereof is provided with a lot of mutually separated and diametrically directed holes 22 for placing therein lamp bulbs 23 of a lamp string, two conductors 24, 25 are provided in and combined with the flexible inner pipe 21 with a PVC pipe 26 coated thereon. The whole flexible lamp pipe 20 with a set length or cut into a desired length is pressed from the upper opening 16 into the notch 17 after being fixed on a wall with screws (not shown) through the fixing holes 11, 12. When there are plural engaging portions 13 or a plurality of shaping units 10 are mutually connected serially, the whole flexible lamp pipe 20 with a set length or cut into a desired length is fixed in position by means of the shaping units 10.

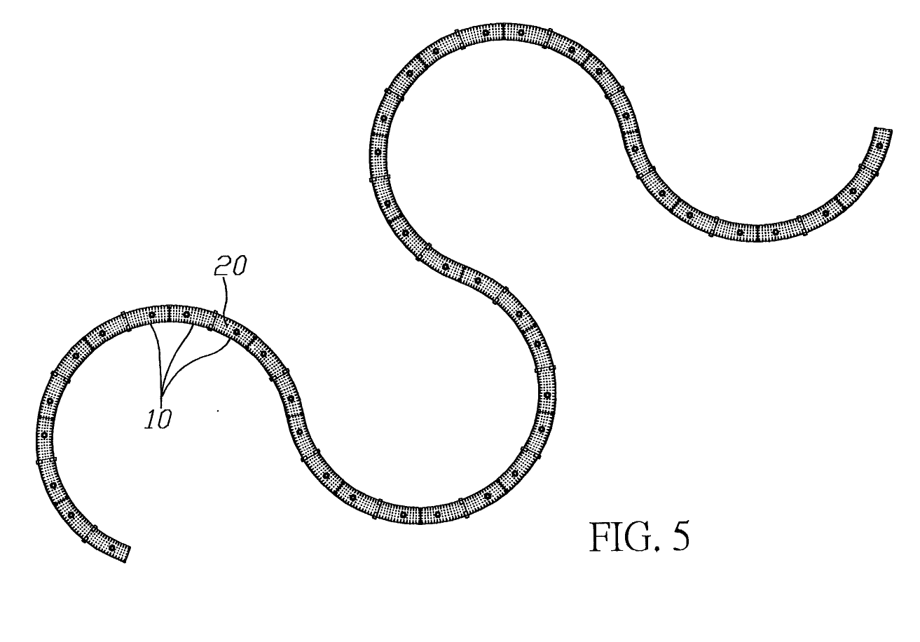

As shown in FIG. 5, when the shaping units 10 in the above embodiment are connected to form a curved pattern depicted, the whole flexible lamp pipe 20 can be accurately positioned in the pattern for decorative illumination.

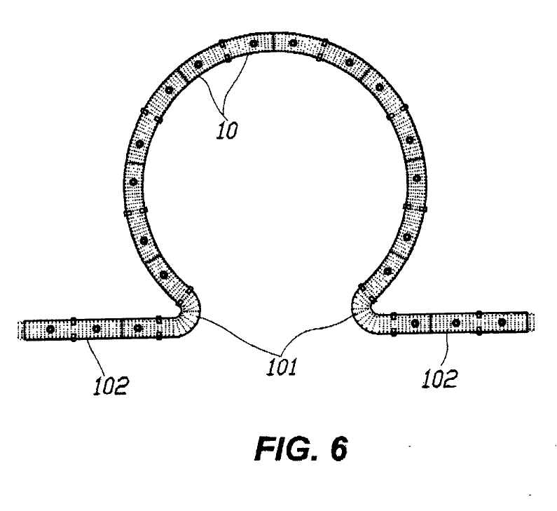

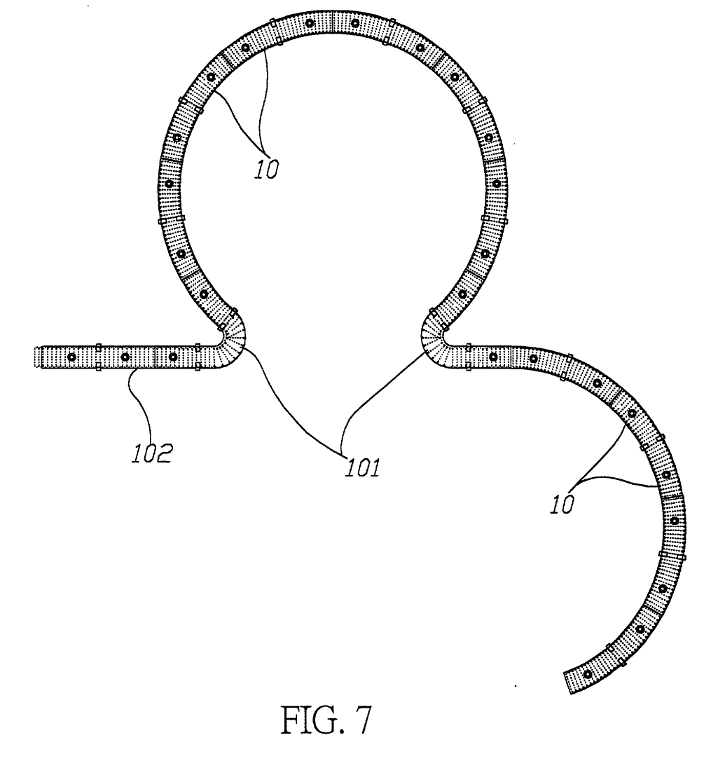

When the decorative pattern includes turnings or straight extensions, such as is shown in FIG. 6, shaping units 101 and 102 can be in the same shape as these turnings or straight extensions, so that the flexible lamp pipe 20 can be positioned in the pattern desired. The shaping units 10, 101 and 102 can be connected to form a pattern as shown in FIG. 7.

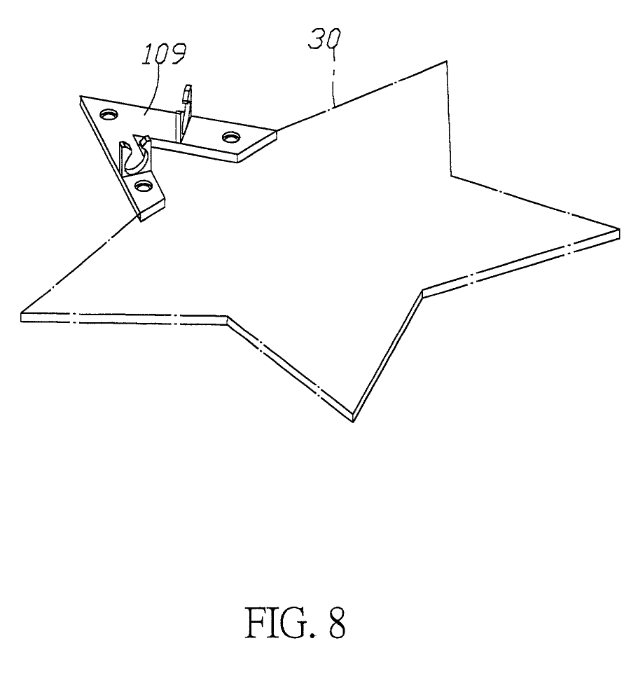

FIG. 8 shows another preferred embodiment of the present invention, wherein, a shaping unit 109 can be formed in advance into a geometric shape as a part of the desired whole pattern 30. In the preferred embodiment shown, the shaping unit 109 is in the shape of a geometric triangle with a notch, and a plurality of such shaping units 109 can be connected to form the desired pattern 30.

The embodiments stated above is only for illustrating a preferred embodiment of the present invention. It will be apparent to those skilled in this art that various modifications or changes can be made to the elements of the present invention without departing from the spirit, and scope of this invention. All such modifications and changes also fall within the scope of the appended claims.

1. A shaping unit for a flexible lamp pipe, having a partial length of a desired pattern for said flexible lamp pipe, said shaping unit is provided with fixing means and an engaging portion for said flexible lamp pipe, said unit is fixed on a mounting surface of said desired pattern by means of said fixing means, said flexible lamp pipe is fixed on said engaging portion of said shaping unit.

2. A shaping unit for a flexible lamp pipe as claimed in claim 1, wherein,
said shaping unit is an arciform piece able to connect with other such shaping units.

3. A shaping unit for a flexible lamp pipe as claimed in claim 2, wherein,
said shaping unit as an arciform piece includes straight extensions.

4. A shaping unit for a flexible lamp pipe as claimed in claim 1, wherein,
said shaping unit is formed with a shape conforming with turnings on said pattern.

5. A shaping unit for a flexible lamp pipe as claimed in claim 1, wherein,
said shaping unit is in a geometric shape, a plurality of such shaping units are adapted to connecting into a pattern.

6. A shaping unit for a flexible lamp pipe as claimed in claim 1, wherein,
said fixing means of said shaping unit is more than one fixing hole.

7. A shaping unit for a flexible lamp pipe as claimed in claim 1, wherein,
said fixing means of said shaping unit includes stickers.

8. A shaping unit for a flexible lamp pipe as claimed in claim 1, wherein,
said engaging portion of said shaping unit has a notch in conforming with said flexible lamp pipe and in communicating with an opening of said engaging portion with a smaller width.
